(19) United States
(12) Patent Application Publication
(10) Pub. No.: US 2025/0314036 A1
(43) Pub. Date: Oct. 9, 2025

(54) REINFORCING STEEL PLATE AND EARTH REMOVAL METHOD

(71) Applicant: Oriental Shiraishi Corporation, Tokyo (JP)

(72) Inventors: Shougo MORI, Tokyo (JP); Yoshiki KOGA, Tokyo (JP); Kuniyuki FUJITA, Tokyo (JP)

(73) Assignee: Oriental Shiraishi Corporation, Tokyo (JP)

(21) Appl. No.: 19/085,247

(22) Filed: Mar. 20, 2025

(30) Foreign Application Priority Data
Apr. 5, 2024 (JP) 2024-061379

(51) Int. Cl. E02D 37/00; E01D 22/00; E02F 3/88

(52) U.S. Cl. CPC E02D 37/00; E01D 22/00; E02F 3/88

(57) ABSTRACT

Provided is a reinforcing steel plate and an earth removal method that can maintain spacing against the pressure at the time of pressing in, and limit the range of an air lift to allow earth to be efficiently removed by the air lift. A reinforcing steel plate 1 to be installed around an existing columnar concrete structure (a PC well 11) for repair or reinforcement includes: a plurality of spacing retaining members (spacer guides 3, 3′) for maintaining spacing with the existing columnar concrete structure (the PC well 11), the plurality of spacing retaining members (the spacer guides 3, 3′) being provided to project from an inner surface; and a partition plate 4 configured to divide a gap G between the reinforcing steel plate 1 and the existing columnar concrete structure (the PC well 11) into a certain range. The partition plate 4 is attached to the inner surface at a side of some of the plurality of spacing retaining members (the spacer guides 3, 3′).

### BACKGROUND

### 1. Technical Field

The present invention relates to a reinforcing steel plate installed around an existing columnar concrete structure for repair or reinforcement, and a method for removing earth around an existing columnar concrete structure using the same.

### 2. Related Art

Conventionally, as a reinforcing method for reinforcing a columnar existing structure such as a bridge pier and foundations thereof, an RC wrapping method or a steel plate wrapping method has been performed. In the RC wrapping method and the steel plate wrapping method, a temporary cofferdam is installed in advance around the existing structure to construct a dry area, then earth and sand is excavated, and a reinforcing material is wrapped around the existing structure. However, these methods have a problem in that it takes time and money for temporary work to install a temporary cofferdam or the like that is not directly related to reinforcement work.

Therefore, a reinforcing steel plate press-in method has been developed in which a reinforcing steel plate is pressed into the ground to reinforce a columnar existing structure such as an existing bridge pier and foundations. This reinforcing steel plate press-in method is superior in workability and economic efficiency, compared with the conventional RC wrapping method and steel plate wrapping method in which a temporary cofferdam is installed to perform an excavation, and therefore, in recent years, it has become the mainstream reinforcing method for a columnar RC structure.

As an earth removal method for removing earth and sand from the reinforcing steel plate in the reinforcing steel plate press-in method, an air lift method or the like has been known. In the air lift method, compressed air or gas is blown into water mixed with earth and sand inside a steel pipe to make the apparent specific gravity of a gas bubble mixed liquid inside the pipe smaller than that of a liquid outside, thereby generating a relative lift force to remove earth. However, simply applying the air lift method has problems such as poor earth removal efficiency and poor workability because the diameter of an earth removal pipe is limited in a narrow gap between a structure such as a bridge pier and the reinforcing steel plate.

For example, JP-A-2003-328385 discloses an earth removing device using an air lift effect from an annular space on the outer periphery of a columnar structure. In the earth removing device using an air lift effect, water supply means for keeping the water level of the annular space at a predetermined water level, a removable partition member that partitions the annular space at predetermined intervals, allowing communication of a lower portion of the annular space, to form a discharge flow path extending in a longitudinal direction, a fluid supply pipe that injects air or a mixture fluid of air and water downward toward a bottom portion of the discharge flow path, and a high-pressure air supply pipe that injects high-pressure air horizontally or obliquely upward at a position above a lowermost end portion of the partition member are provided in the discharge flow path (see claim 1 of the claims, paragraphs [0011] to [0021] of the specification, FIGS. 2 and 3 of the drawings, and the like of JP-A-2003-328385).

However, while the earth removal device using an air lift effect disclosed in JP-A-2003-328385 has improved the earth removal efficiency, there has been such a problem that earth and sand outside the reinforcing steel plate is drawn in from a lower end of the reinforcing steel plate after pressing in, and thus, the workability of earth removing excavation in the final stage is not good.

In order to solve such a problem, the applicant of the present application has proposed, in Japanese Patent No. 6915186, an earth removal method using an earth removal jig of an earth removal device for removing earth and sand in a gap between a reinforcing steel plate and a columnar existing structure when the reinforcing steel plate is pressed into the circumference of the existing structure. The earth removal jig includes a cylindrical earth removal jig main body having an open upper and lower ends. An inlet for injecting compressed gas is formed in a side plate of the earth removal jig main body. In a front plate of the earth removal jig main body on the existing structure side, a suction notch for suctioning earth and sand that opens in a vertical direction is formed, while a back plate on the opposite side has a linear shape with a lower end lower than an upper end of the suction notch and has no notch. In the earth removal method, the earth removal jig is used to remove earth and sand by suctioning earth and sand at a lowermost portion on the existing structure side of the reinforcing steel plate from the suction notch (see claim 1 of the claims, paragraphs [0024] to [0040] of the specification, FIGS. 2 to 4 of the drawings, and the like of Japanese Patent No. 6915186).

The earth removal jig and the earth removal method disclosed in Japanese Patent No. 6915186 eliminate the problem of earth and sand outside the reinforcing steel plate being drawn in, and has good workability of earth removal work in the final stage, allowing earth and sand to be cleanly removed from a corner and a lowermost portion of the reinforcing steel plate. However, in the earth removal jig and the earth removal method disclosed in Japanese Patent No. 6915186, while a stiffener St is provided on the reinforcing steel plate to be pressed in, this is merely a stiffener, and an earth removal jig that limits the range of an air lift is required to efficiently remove earth by an air lift effect.

On the other hand, JP-A-2009-74293 discloses a method for installing an anti-seismic reinforcing steel plate for a columnar structure. In the method, in order to eliminate obstacles by pressing a reinforcing steel plate into an underground structure, ensure the accuracy of steel plate installation, and attempt simplification of earth and sand excavation, the reinforcing steel plate provided with a spacing member as a spacer is pressed into the circumference of a columnar structure such as a bridge pier and installed around the columnar structure.

However, while the reinforcing steel plate disclosed in JP-A-2009-74293 is provided with the spacing member (a spacing retaining member) that maintains spacing against the pressure at the time of pressing in, the spacing member is a spacer to maintain the spacing and is not capable of limiting an area, and no consideration is given at all to limiting the range of an air lift to efficiently remove earth by an air lift effect.

Therefore, the present invention has been made in consideration of the above-described problems, and an object of the present invention is to provide a reinforcing steel plate and an earth removal method that can maintain spacing against the pressure at the time of pressing in, and limit the range of an air lift to allow earth to be efficiently removed by the air lift.

### SUMMARY

A reinforcing steel plate according to a first invention is a reinforcing steel plate to be installed around an existing columnar concrete structure for repair or reinforcement. The reinforcing steel plate includes: a plurality of spacing retaining members for maintaining spacing with the existing columnar concrete structure, the plurality of spacing retaining members being provided to project from an inner surface; and a partition plate configured to divide a gap between the reinforcing steel plate and the existing columnar concrete structure into a certain range. The partition plate is attached to the inner surface at a side of some of the plurality of spacing retaining members.

In the reinforcing steel plate according to a second invention, which is in the first invention, a projection length of the partition plate from the inner surface is set to be shorter than a projection length of the spacing retaining member.

The reinforcing steel plate according to a third invention, which is in the first invention or the second invention, includes a jet guide configured to feed compressed air of an air lift or a water jet used for earth removal to a vicinity of a ground by pressure.

An earth removal method according to a fourth invention is an earth removal method for removing earth and sand from a clearance between a reinforcing steel plate installed around an existing columnar concrete structure and the existing columnar concrete structure. The method includes: using the reinforcing steel plate according to claim 1 or 2, and performing a reinforcing steel plate press-in step for pressing the reinforcing steel plate into a ground with a press-in device while maintaining constant spacing with the existing columnar concrete structure by the spacing retaining member; and removing earth using a pressure of compressed air of an air lift or a water jet in a state where a gap between the reinforcing steel plate and the existing columnar concrete structure is divided into a certain range by the partition plate provided on the reinforcing steel plate.

According to the first invention to the fourth invention, the spacing retaining member can maintain the spacing against the pressure at the time of pressing in of the reinforcing steel plate, and the partition plate can divide the gap between the columnar concrete structure and the reinforcing steel plate into a certain range, limiting the range to which the pressure of the water jet or the air lift is applied to allow earth and sand in the clearance to be efficiently removed.

In particular, according to the second invention, since the projection length of the partition plate from the inner surface is set to be shorter than the projection length of the spacing retaining member, the partition plate is less likely to be damaged at the time of pressing in.

In particular, according to the third invention, since the jet guide is provided, soil clods of any ground can be loosened by the jet guide, allowing earth to be efficiently removed.

### BRIEF DESCRIPTION OF THE DRAWINGS

FIG. 1 is a plan view illustrating a reinforcing steel plate according to an embodiment of the present invention installed around a PC well (a columnar concrete structure);

FIG. 2 is an enlarged view of a part A of FIG. 1;

FIG. 3 is an enlarged view of a part B of FIG. 1;

FIG. 4A is a development diagram of the reinforcing steel plate in the lowermost tier (the first lot) as viewed from an inner surface, and FIG. 4B is a side view thereof;

FIG. 5A is a development diagram of the reinforcing steel plate at a general part as viewed from the inner surface, and FIG. 5B is a side view thereof;

FIG. 6A is a development diagram of the reinforcing steel plate in the uppermost tier as viewed from the inner surface, and FIG. 6B is a side view thereof; and

FIG. 7 is a perspective view illustrating an outline of a construction method for installing the reinforcing steel plate by the PC well refresh method.

### DETAILED DESCRIPTION

The following describes an embodiment of a reinforcing steel plate and an earth removal method using the same according to the present invention in detail with reference to the drawings.

### Reinforcing Steel Plate

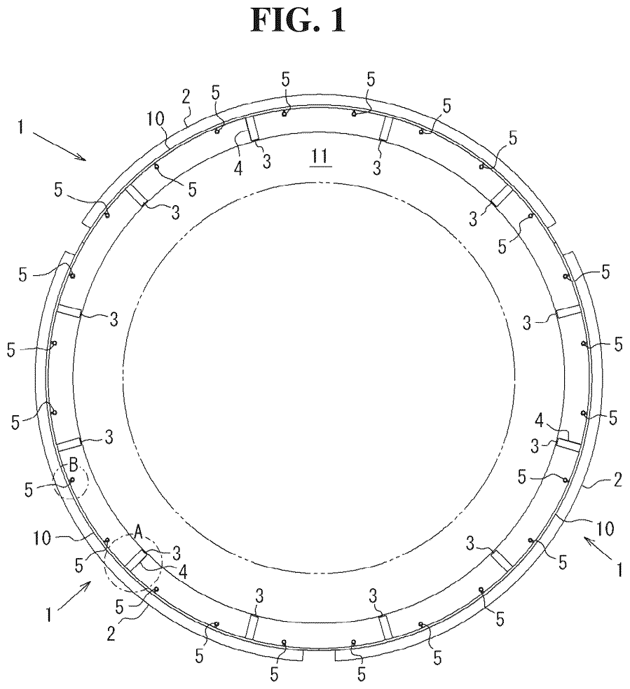

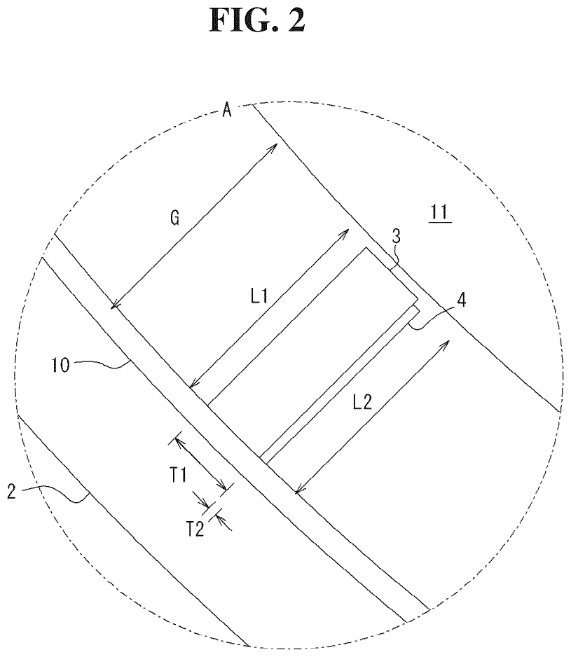

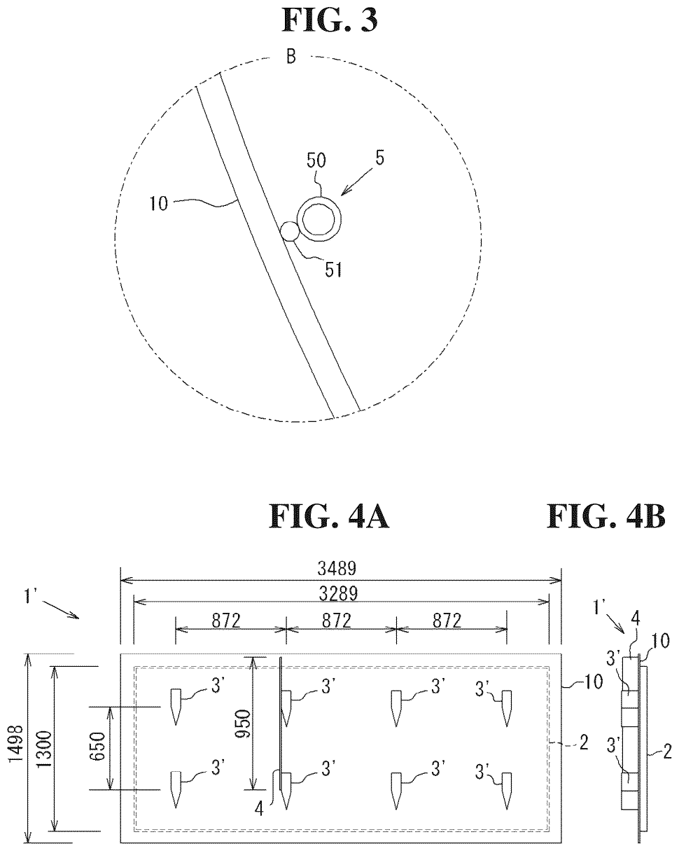

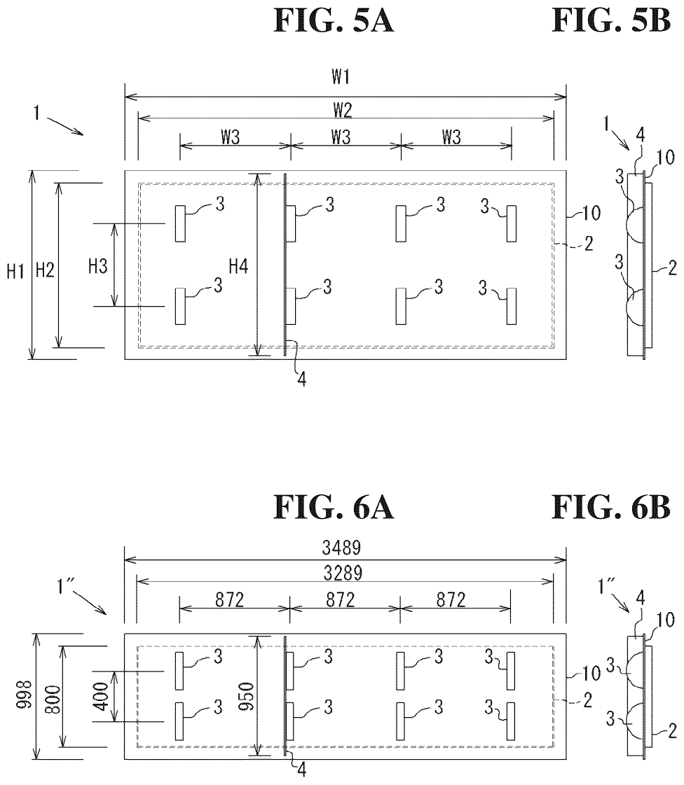

First, a reinforcing steel plate 1 according to an embodiment of the present invention will be described with reference to FIGS. 1 to 6B. A case where the reinforcing steel plate 1 is installed around a PC well 11 of a PC well bridge pier by the PC well refresh method described later to perform reinforcement or repair will be described as an example. FIG. 1 is a plan view illustrating the reinforcing steel plate 1 according to the embodiment of the present invention installed around the PC well 11. FIG. 2 is an enlarged view of a part A of FIG. 1, and FIG. 3 is an enlarged view of a part B of FIG. 1. FIG. 4A is a development diagram of a reinforcing steel plate 1′in the lowermost tier (the first lot) as viewed from an inner surface, and FIG. 4B is a side view thereof. FIG. 5A is a development diagram of the reinforcing steel plate 1 at a general part as viewed from the inner surface, and FIG. 5B is a side view thereof. FIG. 6A is a development diagram of a reinforcing steel plate 1″ in the uppermost tier viewed from the inner surface, and FIG. 6B is a side view thereof.

### Steel Plate Main Body

To take an example of installation around the PC well 11 with a radius of 1500 mm, as illustrated in FIGS. 1 to 6B, the reinforcing steel plate 1 according to the embodiment is a steel plate with a steel plate main body 10 as a base, which is formed into a cylindrical shape with a radius of 1650 mm (the inner diameter is 3300 mm) from a rectangular steel plate having a thickness of about 12 mm to 16 mm and a width W1=3485 mm×a height H1=1500 mm (1498 mm only in the lowermost tier) in a developed state. Of course, the respective dimensions are merely examples, and in the embodiment, when the height is adjusted by two lots of the uppermost lot and the lot below it, the height H1 of each lot is about 1000 mm.

### Stiffener

As illustrated in FIG. 2 and the like, a stiffener 2 for maintaining rigidity during transportation is temporarily fixed and welded to an outer side of the steel plate main body 10 so as to be removable from the steel plate main body 10 at a site. The stiffener 2 is formed by joining steel strips with a thickness 9 mm×a width 65 mm into a rectangular frame shape with a width W2=3285 mm×a height H2=1300. Although not shown, a flat bar with a thickness 6 mm×a width 50 is attached as a backing metal during welding along horizontal and vertical edges of the steel plate main body 10.

### Spacer Guide

As illustrated in FIGS. 1, 2, and the like, on an inner peripheral surface of the reinforcing steel plate 1, a plurality of spacer guides 3 made of a steel material having a thickness T1=30 mm are provided to project at predetermined intervals (in the illustrated embodiment, horizontal spacing W3=872 mm, and vertical spacing H3=650 mm) as a spacing retaining member for maintaining spacing (a clearance) with the PC well 11.

As illustrated in FIGS. 4A and 4B, in the reinforcing steel plate 1′ in the lowermost tier, which is the first lot, the spacer guide 3 is a wedge-shaped spacer guide 3′ having a sharp lower end in order to be pressed into the ground. As illustrated in FIGS. 5A, 5B, 6A, and 6B, in the reinforcing steel plate 1 at the general part in the second tier or higher from the second lot, and the reinforcing steel plate 1″ in the uppermost tier, the spacer guide 3 has a semicircular shape. A designed gap G between the PC well 11 and the steel plate main body 10 is set to be 150 mm, and a projection length L1 of the spacer guide 3 from the inner peripheral surface of the steel plate main body 10 is set to be 140 mm.

### Partition Plate

As illustrated in FIGS. 1, 2, and 4A to 6B, a partition plate 4 made of a steel strip with a thickness T2=6 mm or 9 mm and a projection width L2=135 mm is attached to the side of some of the spacer guides 3. The partition plate 4 has a function of limiting the range of the air lift by dividing the gap between the PC well 11 and the steel plate main body 10 into a certain range.

In the reinforcing steel plate 1 according to the embodiment, as described above, the projection length L1=140 mm of the spacer guide 3 from the inner peripheral surface of the steel plate main body 10 is set, and the projection width L2 of the partition plate 4 placed at the side thereof is set to L2=135 mm, which is shorter than the projection length of the spacer guide 3. Therefore, no pressure is applied to the partition plate 4 even at the time of pressing in of the reinforcing steel plate 1, and even when the steel plate has the thickness T2=6 mm or 9 mm, there is no risk of being damaged at the time of pressing in.

### Jet Guide

As illustrated in FIGS. 1 and 3, in the illustrated embodiment, 24 jet guides 5 are attached to the inner peripheral surface of the steel plate main body 10 at even predetermined intervals. The jet guide 5 includes a guide pipe 50 that feeds compressed air or a water jet to the lower portion of the reinforcing steel plate 1′in the lowermost tier, and a steel rod 51 as a spacer for fixing the guide pipe 50 at a distance from the inner peripheral surface of the steel plate main body 10. The jet guide 5 has a function of loosening soil clods of any ground so that an air pipe or the like is connected to the top end of the reinforcing steel plate 1 in the uppermost tier with a catch clamp or the like to remove earth. In view of this, the attachment position of the jet guide 5 is not limited to the illustrated embodiment, and the jet guide 5 is provided at any position according to the conditions of the ground at the site or the like.

### Construction Method of Reinforcing Steel Plate and Earth Removal Method

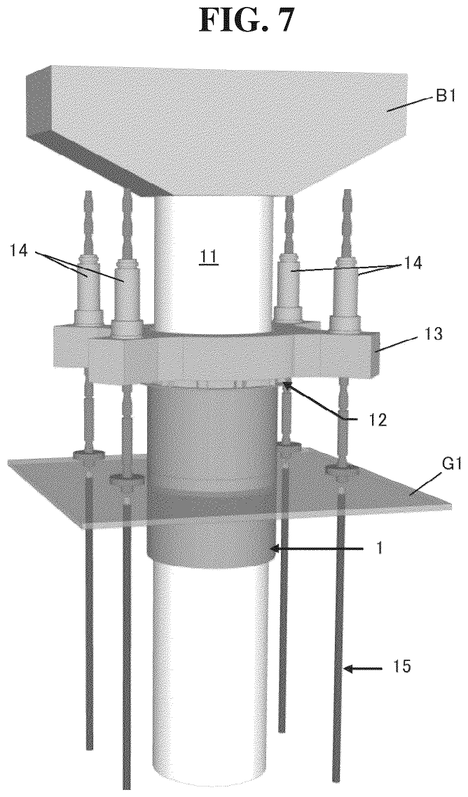

Next, a construction method of the reinforcing steel plate 1 described above and the earth removal method according to the embodiment of the present invention will be described with reference to FIG. 7. FIG. 7 is a perspective view illustrating an outline of the construction method for installing the reinforcing steel plate 1 by the PC well refresh method. As illustrated in FIG. 7, the construction method of the reinforcing steel plate according to the embodiment is performed by the PC well refresh method. In the PC well refresh method, a press-in mount 13 is suspended from a pier head of a PC well bridge pier B1, which is an existing columnar concrete structure, and a press-in ring 12 is bolted and fixed to the press-in mount 13. In addition, a plurality of press-in jacks 14 are mounted to the press-in mount 13, and the reinforcing steel plate 1 is wrapped around the PC well 11 and pressed into a ground G1 while a reaction force is taken with ground anchors 15 using the press-in jacks 14. Then, the reinforcing steel plate 1 is integrated with the PC well bridge pier B1 using a filler such as underwater non-separable non-shrinking mortar to attempt an improvement of anti-seismic performance.

### Press-In Device Installation Step

First, in the construction method of the reinforcing steel plate according to the embodiment, a press-in device installation step is performed in which the press-in mount 13 is suspended from and supported by the pier head of the PC well bridge pier B1, and the press-in ring 12 and the plurality of press-in jacks 14 are mounted to the press-in mount 13. In this step, the ground anchors 15 are installed in the ground G1 such that a reaction force can also be taken from the ground G1 when the press-in jacks 14 are used for pressing in.

### First Lot Assembly Step

Next, in the construction method of the reinforcing steel plate according to the embodiment, a first lot assembly step of assembling the first lot of the reinforcing steel plate described above is performed. Specifically, in this step, the above-described plurality of reinforcing steel plates 1′ to be the lowermost tier are welded and assembled in a cylindrical shape around the PC well 11.

### Reinforcing Steel Plate Press-In Step

Next, in the construction method of the reinforcing steel plate according to the embodiment, a reinforcing steel plate press-in step is performed in which the first lot of the reinforcing steel plates assembled in a cylindrical shape is pressed into the ground G1 using the press-in jacks 14.

At this time, as described above, the spacer guide 3 is attached to the reinforcing steel plate 1, and thus, the reinforcing steel plate 1 can be vertically pressed into the ground G1 while maintaining a constant clearance between the PC well 11 and the reinforcing steel plate 1.

Moreover, as described above, the projection width L2 of the partition plate 4 provided at the side of the spacer guide 3 is set to the projection width L2=135 mm, which is slightly shorter than the projection length L1 of the spacer guide 3=140 mm (see FIG. 2), and thus, no pressure is applied to the partition plate 4 even at the time of pressing in, and there is no risk of being damaged at the time of pressing in.

### Subsequent Lot Assembly Step

Next, in the construction method of the reinforcing steel plate according to the embodiment, a subsequent lot assembly step is performed in which a plurality of the reinforcing steel plates 1 are welded to assemble a subsequent lot of the reinforcing steel plates 1, such as the second lot, in a cylindrical shape around the PC well 11.

### Reinforcing Steel Plate Press-In Step

Next, a reinforcing steel plate press-in step is performed in which the lot of the reinforcing steel plates 1 assembled in a cylindrical shape is pressed into the ground G1 using the press-in jacks 14. At this time, the lot of the reinforcing steel plate 1 is pressed into the ground G1 while partially removing earth and sand from the upper portion of the ground G1 using a water jet, an air lift, and the like in combination, depending on the hardness and conditions of the ground G1.

Then, the subsequent lot assembly step and the reinforcing steel plate press-in step are repeated to form a reinforcing steel plate assembly having a predetermined height (predetermined tiers).

### Clearance Washing Step

Then, a clearance washing step of washing the clearance between the PC well 11 and the reinforcing steel plate 1 with a water jet or the like is performed. Specifically, a water jet or compressed air is fed by pressure, and earth and sand in the clearance is removed as muddy water by an air lift through the upper end of the reinforcing steel plate 1. This process is continued until the muddy water that blows up becomes clear water, thereby washing the clearance between the PC well 11 and the reinforcing steel plate 1.

At this time, since the partition plate 4 made of a steel strip is attached to the reinforcing steel plate 1 as described above, the partition plate 4 can divide the gap between the PC well 11 and the steel plate main body 10 into a certain range, limiting the range to which the pressure of the water jet or the air lift is applied to allow earth and sand in the clearance to be efficiently removed.

### Filler Filling Step

Next, in the construction method of the reinforcing steel plate according to the embodiment, a filler filling step is performed in which the clearance between the PC well 11 and the reinforcing steel plate 1 that has been washed in the clearance washing step is filled with a filler such as underwater non-separable non-shrinking mortar.

Then, the filler filled in the filler filling step hardens, and the installed reinforcing steel plate 1 is integrated with the PC well bridge pier B1, thus completing the construction method of the reinforcing steel plate according to the embodiment.

However, when reinforcement is required for the upper portion of the PC well 11 on which the press-in devices such as the press-in ring 12, the press-in mount 13, and the press-in jacks 14 are installed, the upper portion is also wrapped with the reinforcing steel plate, and a necessary anticorrosive coating or the like is applied to the upper portion.

In the reinforcing steel plate 1 and the earth removal method using the same according to the embodiment of the present invention described above, the spacer guide 3 as a spacing retaining member can maintain spacing against the pressure at the time of pressing in. In addition, since the partition plate 4 made of a steel strip is attached to the inside of the reinforcing steel plate 1, the gap between the PC well 11 and the steel plate main body 10 can be divided into a certain range, limiting the range to which the pressure of the water jet or the air lift is applied to allow earth and sand in the clearance to be efficiently removed.

In the reinforcing steel plate 1 and the earth removal method using the same according to the embodiment, the projection width L2 of the partition plate 4 provided at the side of the spacer guide 3 is set to the projection width L2=135 mm, which is slightly shorter than the projection length L1 of the spacer guide 3=140 mm. Therefore, no pressure is applied to the partition plate 4 even at the time of pressing in of the reinforcing steel plate 1, and there is no risk of being damaged at the time of pressing in.

The reinforcing steel plate 1 and the earth removal method using the same according to the embodiment of the present invention have been described in detail above. However, any of the above-described or illustrated embodiments is merely one embodiment embodied in carrying out the present invention. Accordingly, the technical scope of the present invention should not be construed in a limited manner by these.

### DESCRIPTION OF REFERENCE SIGNS

1, 1′, 1″: Reinforcing steel plate
10: Reinforcing steel plate main body
2: Stiffener
3, 3′: Spacer guide (spacing retaining member)
4: Partition plate
5: Jet guide
50: Guide pipe
51: Steel rod
G: Gap (clearance)
11: PC well (columnar concrete structure)
12: Press-in ring
13: Press-in mount
14: Press-in jack
15: Ground anchor
P1: PC well bridge pier
G1: Ground

What is claimed is:

1. A reinforcing steel plate to be installed around an existing columnar concrete structure for repair or reinforcement, comprising:
a plurality of spacing retaining members for maintaining spacing with the existing columnar concrete structure, the plurality of spacing retaining members being provided to project from an inner surface; and
a partition plate configured to divide a gap between the reinforcing steel plate and the existing columnar concrete structure into a certain range, the partition plate being attached to the inner surface at a side of some of the plurality of spacing retaining members.

2. The reinforcing steel plate according to claim 1, wherein
a projection length of the partition plate from the inner surface is set to be shorter than a projection length of the spacing retaining member.

3. The reinforcing steel plate according to claim 1, further comprising
a jet guide configured to feed compressed air of an air lift or a water jet used for earth removal to a vicinity of a ground by pressure.

4. An earth removal method for removing earth and sand from a clearance between a reinforcing steel plate installed around an existing columnar concrete structure and the existing columnar concrete structure, the method comprising:
using the reinforcing steel plate according to claim 1, and performing a reinforcing steel plate press-in step for pressing the reinforcing steel plate into a ground with a press-in device while maintaining constant spacing with the existing columnar concrete structure by the spacing retaining member; and
removing earth using a pressure of compressed air of an air lift or a water jet in a state where a gap between the reinforcing steel plate and the existing columnar concrete structure is divided into a certain range by the partition plate provided on the reinforcing steel plate.
